(19) United States
(12) Patent Application Publication
(10) Pub. No.: US 2014/0091038 A1
(43) Pub. Date: Apr. 3, 2014

(54) APPARATUS AND METHOD FOR IONIC CONTAMINANT REMOVAL IN LIQUIDS

(71) Applicant: Anja Mueller, Mt. Pleasant, MI (US)

(72) Inventor: Anja Mueller, Mt. Pleasant, MI (US)

(73) Assignee: CENTRAL MICHIGAN UNIVERSITY, Mount Pleasant, WI (US)

(21) Appl. No.: 14/122,604

(22) PCT Filed: May 31, 2012
(86) PCT No.: PCT/US12/40248

§ 371 Date: Nov. 26, 2013

Related U.S. Application Data
(60) Provisional application No. 61/491,742, filed on May 31, 2011.

(51) Int. Cl. C02F 1/42; C02F 1/44

(52) U.S. Cl. CPC C02F 1/42; C02F 1/444
USPC 210/636; 210/263; 210/287; 210/638

(57) ABSTRACT

The present application provides an apparatus for removal of an ionic contaminant from a liquid comprising a branched polymer, a filtration membrane, and a filter casing. The application also provides a method of removing an ionic contaminant from a liquid, the method comprising directing ion-contaminated liquid into and draining treated liquid from an apparatus as described in the instant specification.

### CROSS-REFERENCE TO RELATED APPLICATIONS

This application claims priority under 35 U.S.C. §119(e) to U.S. Provisional Patent Application No. 61/491,742 filed on May 31, 2011. The entire contents of this application are hereby incorporated by reference in its entirety.

### GOVERNMENT LICENSE RIGHTS

This invention was made with government support from a United States of America Department of Defense Strategic Environmental Research and Development Program (SERDP) grant number W912HQ-07-C-0049 (ER-1599). The United States federal government has certain rights in the invention.

### BACKGROUND

The subject matter relates generally to apparatuses for and methods of removal of an ionic contaminant from a liquid.

Perchlorate is a persistent environmental contaminant with a variety of health effects. Unregulated past releases of perchlorate, for example, from plants preparing rocket fuel, have contaminated ground water mainly in the western United States; additional natural and industrial sources are also being discovered. Regulation of perchlorate is in the process of changing. Drinking water standards are still being discussed and may be adjusted to set allowable levels of perchlorate at as low as 4 ppb.

The perchlorate ion is highly soluble in water and highly stable; perchlorate ions may have only a very low affinity to sand or resins commonly used in water treatment and thus can be difficult to remove from water. Ion exchange resins and microbiological degradation have been used for remediation of water contaminated with perchlorate ion.

### SUMMARY

Embodiments of the present disclosure may relate to apparatuses for removal of an ionic contaminant from a liquid. In some embodiments, the apparatus may include a branched polymer, a filtration membrane, and a filter casing. Liquid may enter the filter casing through a first opening, contact a filtration membrane including a branched polymer inside the filter casing, and exit the filter casing through a second opening in the filter casing. Liquid exiting the filter casing may contain less of an ionic-contaminant than the liquid entering the filter casing. In some embodiments, the ionic contaminant may comprise perchlorate ion. In some embodiments, the filter casing can include a third opening that may serve as an inlet or an outlet for regeneration fluids.

This disclosure also provides methods of removing an ionic contaminant from a liquid. In some embodiments, the method may comprise directing ion-contaminated liquid into an apparatus, the apparatus comprising a branched polymer, a filtration membrane, and a filter casing, wherein the filter casing comprises a first opening for admitting liquid and a second opening for releasing liquid; contacting the ion-contaminated liquid with the branched polymer and directing the ion-contaminated liquid through the filtration membrane to produce a treated liquid; and draining the ion-contaminated liquid from the apparatus through the second opening. In some embodiments, the treated liquid contains less ionic contaminant than the ion-contaminated liquid.

In some embodiments, the branched polymer may comprise a backbone with a degree of polymerization of about 5 to about 800. In some embodiments, the branched polymer may comprise branches with a degree of polymerization of about 5 to about 500. In some embodiments, the branched polymer may comprise a molecular weight of about 5,000 to about 1,000,000 Da. In some embodiments, the branched polymer may comprise a dendrimer or a hyperbranched polymer. In some embodiments, the branched polymer may comprise poly(ethyleneimine), poly(amido amine), polyamide, or a combination thereof. In some embodiments, the branched polymer may comprise a perchlorate ion binding site. In some embodiments, the perchlorate ion binding site may comprise tributyl ammonium chloride, triethyl ammonium chloride, trimethyl ammonium chloride, or a combination thereof. In some embodiments, the perchlorate ion binding site has a stronger binding affinity for perchlorate ions than for nitrate or sulfate ions.

In some embodiments, the filtration membrane may comprise cellulose, polycarbonate, cellulose acetate, nylon, polysulfone, polyethersulfone, polyetherketone, polyetheretherketone, polyimide, polypropylene, polyvinylidenefluoride, polytetrafluoroethylene, or a combination thereof. In some embodiments, the filtration membrane may comprise pores having a pore size from about 5 kDa to about 30 kDa. In some embodiments, the filtration membrane may comprise about 0.01 mg to about 10 mg of a branched polymer per square centimeter of membrane. In some embodiments, the filtration membrane comprising the branched polymer may be regenerated after exposure to perchlorate ion with a saline solution comprising less than 1 M sodium chloride.

In some embodiments, the liquid comprises water. In some embodiments, the ionic contaminant comprises the perchlorate ion. In some embodiments, the ion-contaminated liquid comprises perchlorate ion-contaminated water.

In some embodiments, the filter casing may be fluidly connect to a water faucet, a refrigerator water filter, a water filtration pitcher, or a combination thereof.

Other aspects of the invention will become apparent by consideration of the detailed description and accompanying drawings.

### BRIEF DESCRIPTION OF THE DRAWINGS

FIG. 1 shows a schematic cross-section of one embodiment of an apparatus for removal of perchlorate ion from a liquid.

FIG. 2 shows a comparison of the active surface area of current anion exchange beads with branched polymer material.

FIG. 3 is a graph illustrating perchlorate retention in permeate of branched polymers with a G1(100-30) backbone with TMAC, TEAC, and TBAC binding sites using 100 ppm perchlorate ion solution and filter paper.

FIG. 4 is a graph illustrating perchlorate retention in retentate of branched polymers with a G1(100-30) backbone with TMAC, TEAC, and TBAC binding sites using 100 ppm perchlorate ion solution and filter paper.

FIG. 5 is a graph illustrating perchlorate retention in permeate of branched polymers with a G1(100-30) backbone with TMAC, TEAC, and TBAC binding sites using 1,000 ppm perchlorate ion solution and filter paper.

FIG. 6 is a graph illustrating perchlorate retention in retentate of branched polymers with a G1(100-30) backbone with TMAC, TEAC, and TBAC binding sites using 1,000 ppm perchlorate ion solution and filter paper.

FIG. 7 is a graph illustrating perchlorate retention in retentate of branched polymers with different length backbone using 10,000 ppm perchlorate ion solution and filter paper.

FIG. 8 is a graph illustrating the relative selectivity of first and second generation cross-linked branched polymer resins substituted with TMAC, TEAC, and TBAC when exposed to nitrate, sulfate, or perchlorate ions.

FIG. 9 is a graph summarizing experiments showing the relative selectivity of a cross-linked branched polymer backbone resin G1(200-60), when exposed to chloride, nitrate, sulfate, or perchlorate ions.

FIG. 10 is a graph summarizing experiments showing comparative effluent chloride concentration for G1(200-60) backbone and G1(200-60)-TMAC cross-linked branched polymer samples for total capacity analysis.

FIG. 11 shows a schematic example of the relationship between a monomer and a branched polymer.

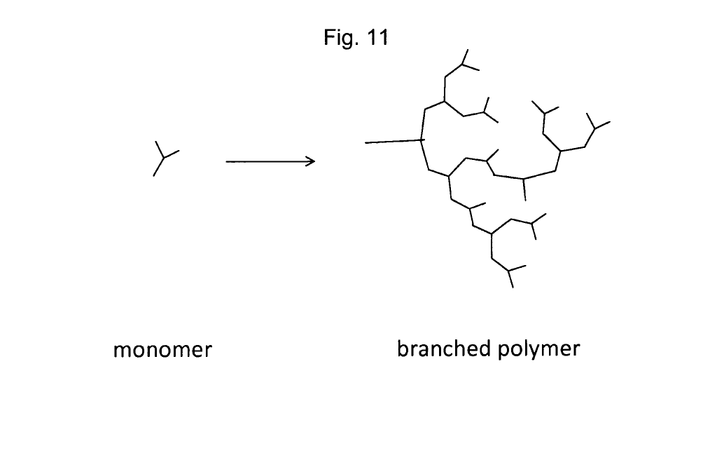

### DETAILED DESCRIPTION

Before any embodiments of the invention are explained in detail, it is to be understood that the present disclosure is not limited in its disclosure to the specific details of construction, arrangement of components, or method steps set forth herein. The compositions and methods disclosed herein are capable of being made, practiced, used, carried out and/or formed in various ways. The phraseology and terminology used herein is for the purpose of description only and should not be regarded as limiting. Ordinal indicators, such as first, second, and third, as used in the description and the claims to refer to various structures or method steps, are not meant to be construed to indicate any specific structures or steps, or any particular order or configuration to such structures or steps. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification, and no structures shown in the drawings, should be construed as indicating that any non-claimed element is essential to the practice of the invention. The use herein of the terms “including,” “comprising,” or “having,” and variations thereof, is meant to encompass the items listed thereafter and equivalents thereof, as well as additional items. Unless specified or limited otherwise, the terms “mounted,” “connected,” “supported,” and “coupled” and variations thereof encompass both direct and indirect mountings, connections, supports, and couplings. Further, “connected” and “coupled” are not restricted to physical or mechanical connections or couplings.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein. All references cited herein are fully incorporated by reference, unless explicitly indicated otherwise. The present disclosure shall control in the event there are any disparities.

One aspect provides a device for removal of ionic contaminants from a liquid. The device can include a branched polymer, a filtration membrane, and a filter casing. In some embodiments, the ionic contaminant may include perchlorate ion.

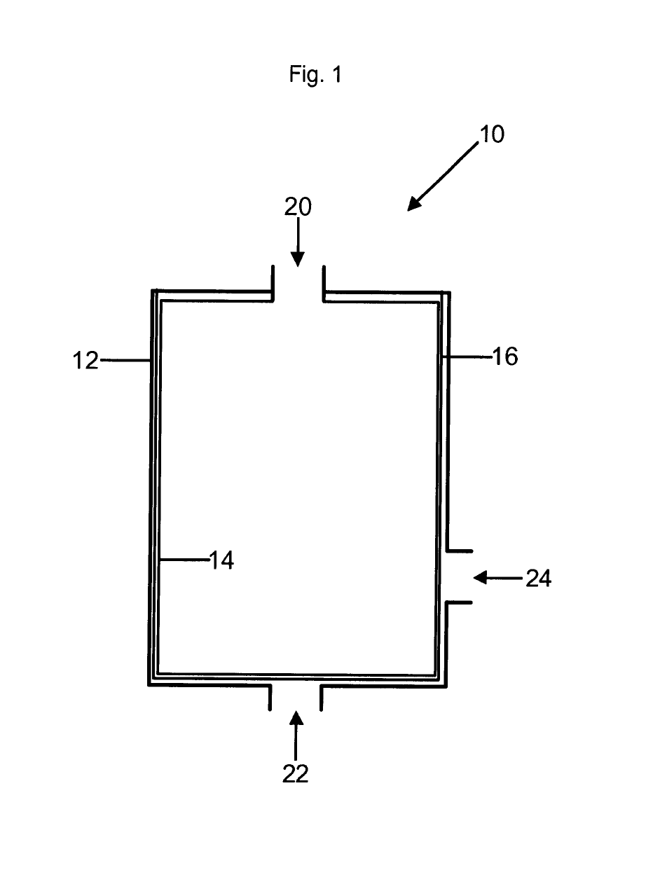

A cross-sectional schematic of one embodiment of a filtration device for removal of perchlorate ion from a liquid is shown in FIG. 1. Referring to FIG. 1, the filtration device 10 includes a filter casing 12 having a first opening 20 and a second opening 22. Liquid can enter the filter casing 12 through the first opening 20 and exit the filter casing 12 through the second opening 22. A filter paper 14 having an opening on its top surface is positioned inside the filter casing 12. The side and bottom interior surfaces of the filter casing are lined with a membrane 16 including a branched polymer that is positioned between the filter casing and the filter paper. The filter casing includes a third opening 24 that may serve as an inlet or an outlet for regeneration fluids.

Liquid exiting the filtration device may contain less perchlorate ion than liquid entering the filtration device. In some embodiments, liquid exiting the filtration device may contain less than about 24.5 parts per billion of perchlorate ion. In some embodiments, liquid exiting the filtration device may contain less than about 6 parts per billion of perchlorate ion, less than about 4 parts per billion of perchlorate ion, or less than about 2 parts per billion of perchlorate ion.

### Branched Polymers

As used herein, the term “branched polymer” refers to a molecule comprising a main chain with one or more substituent side chains. Branched polymers include, without limitation, hyperbranched polymers, dendrimers, star polymers, comb polymers, and brush polymers, among others. In some embodiments, the branched polymer may comprise poly(ethyleneimine), poly(amido amine), polyamide, or a combination thereof.

In some embodiments, a filtration device for removal of perchlorate ion from a liquid may include a branched polymer. Methods for preparation of branched polymers are known to those skilled in the relevant arts. In some embodiments, the branched polymer may include perchlorate binding sites, such as, for example, TMAC, TEAC, TBAC, or tripropyl ammonium chloride binding sites. In some embodiments, the branched polymer may include an amine. In some embodiments, the branched polymer may include an amide.

The synthesis of branched polymers may be performed in a reiterative method that increases the size of the molecule exponentially and reduces the cost of synthesis. Each step and thus set of branches symbolizes a new “generation”, termed G1, G2, G3, etc. G1 branched polymers contain a backbone and one generation of branches attached to the backbone. G2 branched polymers contain a backbone, a first generations of branches attached to the backbone, and a second generation of branches attached to the first generation. Different generations with different branching lengths may be synthesized and compared.

As used herein, the nomenclature for branched polymers shall be such that the generation is listed first, a description of the length of the polymer backbone and branches is listed second, and the presence and identity of a binding site is optionally listed third. The description of the length of the polymer backbone and branches is ordered such that the length of the backbone is first, followed by the length of the first generation of branches, followed by the length of the second generation of branches, etc. For example, a branched polymer having a backbone with a degree of polymerization of about 100 and having branches with a degree of polymerization of about 30 would be represented by the name G1(100-30). Addition of TMAC binding sites to a polymer having a backbone with a degree of polymerization of about 100 and having branched with a degree of polymerization of about 30 would be represented by the name G1(100-30)-TMAC.

As used herein, G1A is shorthand for G1(100-30), G1B is shorthand for G1(200-60), G2A is shorthand for G2(100-30-15), and G2B is shorthand for G2(200-60-30). Similarly, G1A-TMAC is used as shorthand for G1(100-30)-TMAC, G2B-TEAC is used as shorthand for G2(200-60-30)-TEAC, etc.

Methods of preparation of branched polymers suitable for use in embodiments of the present disclosure are known to those skilled in the relevant arts and are described by Mueller in “Perchlorate Remediation Using New Nanoscale Polymer Technology” SERDP Project ER-1599, the entire contents of which are hereby incorporated by reference.

In some embodiments, the branched polymer may have a backbone with a degree of polymerization of about 5 to about 800. In some embodiments, the branched polymer may have a backbone with a degree of polymerization of greater than about 5, greater than about 20, greater than about 50, greater than about 100, greater than about 200, greater than about 300, greater than about 400, greater than about 500, greater than about 600, greater than about 700. In some embodiments, the branched polymer may have a backbone with a degree of polymerization of less than about 800, less than about 700, less than about 600, less than about 500, less than about 400, less than about 300, less than about 200, less than about 100, or less than about 50. In some embodiments, the branched polymer may have a backbone of about 100 or about 200. In some embodiments, the branched polymer may have branches with a degree of polymerization of about 5 to about 500. In some embodiments, the branched polymer may have branches with a degree of polymerization of greater than about 5, greater than about 10, greater than about 15, greater than about 25, greater than about 30, greater than about 50, greater than about 60, greater than about 100, greater than about 200, greater than about 300, greater than about 400. In some embodiments, the branched polymer may have branches with a degree of polymerization of less than about 500, less than about 400, less than about 300, less than about 200, less than about 100, less than about 75, less than about 60, less than about 50, less than about 30, less than about 25, less than about 15, or less than about 10. In some embodiments, the branched polymer may have branches with a degree of polymerization of about 15, about 30, or about 60. In some embodiments, the branched polymer may have a molecular weight of about 5,000 to about 1,000,000 Da.

In some embodiments, the branched polymer may be a dendrimer. In some embodiments, the dendrimer may be a G1 polymer, a G2 polymer, a G3 polymer or a G4 polymer. In some embodiments, the branched polymer may be a hyperbranched polymer. In some embodiments, the hyperbranched polymer may have a molecular weight of about 5,000 to about 1,000,000 Da.

In some embodiments, the branched polymer may include at least one perchlorate binding site. In some embodiments, the perchlorate binding site may include an amine. In some embodiments, the amine may include a primary amine, a secondary amine, a tertiary amine, or a quaternary amine, or a combination thereof.

In some embodiments, the perchlorate binding site may include at least one ammonium ion. In some embodiments, the ammonium ion may include a trialkyl ammonium chloride, such as, for example, tributyl ammonium chloride (“TBAC”), triethyl ammonium chloride (“TEAC”), trimethyl ammonium chloride (“TMAC”), tripropyl ammonium chloride, or a combination thereof. In some embodiments, the branched polymer may be a first generation branched polymer (G1), with a backbone including a poly(ethyleneimine) (degree of polymerization of 200) core and polyoxazoline (degree of polymerization of 60) branches (G1(200-60)), and trimethyl ammonium binding sites (G1(200-60)-TMAC).

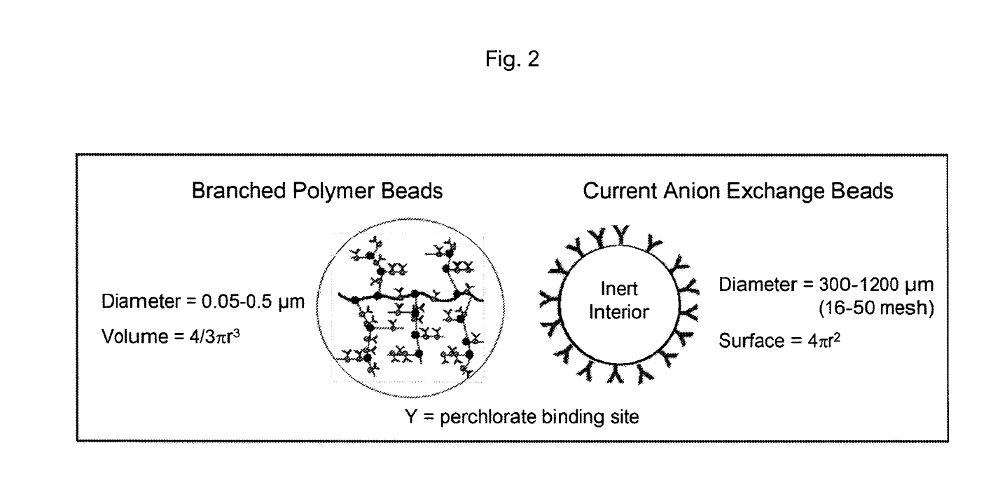

FIG. 2 shows a comparison of the active surface area of an anion exchange bead with that of a branched polymer material. Referring to FIG. 2, on the right is a drawing of a typical anion exchange bead including an inert interior and perchlorate binding sites, shown as “Ys” attached to the bead surface. On the left is a drawing of the chemical structure of a soluble material including a branched polymer showing the polymer backbone with attached “Ys” representing the binding sites specific for perchlorate ion.

### Membranes

The ion filtration device may include a membrane. In some embodiments, the membrane may include an ultrafiltration membrane, such as, for example, a regenerated cellulose membrane available from Whatman Inc., Piscataway, N.J., or Millipore, Billerica, Mass. In some embodiments, the membrane may have a pore size from about 5 kDa to about 30 kDa. In some embodiments, the ultrafiltration membrane may include a regenerated cellulose ultrafiltration membrane. In some embodiments, the membrane may include a 10 kDa regenerated cellulose ultrafiltration membrane such as, for example, ULTRACEL™ PLC membrane (Millipore, Billerica, Mass.). In some embodiments, the filtration membrane may comprise a cellulose, polycarbonate, cellulose acetate, nylon, polysulfone, polyethersulfone, polyetherketone, polyetheretherketone, polyimide, polypropylene, polyvinylidenefluoride, polytetrafluoroethylene, or a combination thereof.

In some embodiments, the membrane may include a branched polymer, such as those described above. In some embodiments, the membrane may include about 0.01mg to about 10 mg of a branched polymer per square centimeter of membrane. In some embodiments, the membrane including branched polymer may have a total capacity for perchlorate ion of at least about 1 milli equivalents, at least about 5 milli equivalents, at least about 25 milli equivalents, at least about 50 milli equivalents, at least about 75 milli equivalents, at least about 100 milli equivalents, at least about 200 milli equivalents, or at least about 300 milli equivalents. In some embodiments, the membrane including branched polymer may have a total capacity for perchlorate ion of at least about 325 milli equivalents.

In some embodiments, the membrane including branched polymer may be regenerated after exposure to perchlorate ion. In some embodiments, regeneration may be accomplished with water. In some embodiments, regeneration may be accomplished with a saline solution. In some embodiments, the saline solution may have a sodium chloride concentration of less than about 1M, less than about 0.5 M, or less than about 0.25 M. In some embodiments, the saline solution may have a sodium chloride concentration of less than about 0.1 M, less than about 0.05 M, less than about 0.001 M, or less than about 0.0001M.

### Filter Casing

Suitable filter casings for use in embodiments of the present disclosure are known to those skilled in the relevant arts and are described in, for example, U.S. Pat. No. 4,536,290, U.S. Pat. No. 5,273,665, and U.S. Pat. No. 5,652,008, all of which are hereby incorporated by reference in their entireties. In some embodiments, the filter casing may comprise a molded plastic material.

In some embodiments, the filter casing may be adapted to fluidly connect to a water faucet. In some embodiments, the filter casing may be adapted for use in a pitcher filter. In some embodiments, the filter casing may be adapted for use in a refrigerator water filter. In some embodiments, the filter casing may be adapted for use in a point-of-entry filtration system.

### EXAMPLES

### Example 1

### Choice of Binding Site

To determine the best binding sites, a G1(100-30) backbone was substituted with three possible binding sites: TMAC, TEAC and TBAC. The different backbones were tested for perchlorate binding efficiency.

Sample preparation for ultrafiltration measurements for soluble resins: All sodium perchlorate and branched polymer solutions were prepared in deionized (“DI”) water. A solution of branched polymer (1 g/50 mL) prepared in DI water was combined with a solution of NaClO₄ (50 mL, 2 ppm) to provide 100 mL of 1 ppm perchlorate-branched polymer solution. This solution was stirred at room temperature for about 1 hour and then filtered through ultrafiltration membranes (two 10 kDa regenerated cellulose membranes (Millipore, Billerica, Mass.) four recirculation's collecting 100 mL of permeate). A sample of retentate (2 mL) and permeate (2 mL) was collected after each recirculation. During ultrafiltration, the volume of retentate was kept constant by adding DI water. A total of four permeate and four retentate samples were collected from each experiment. Additional solutions including 10 ppm, 100 ppm, 1,000 ppm and 10,000 ppm sodium perchlorate and branched polymer (G1-TMAC, G1-TEAC, and G1-TBAC) samples were prepared by following the same experimental procedure.

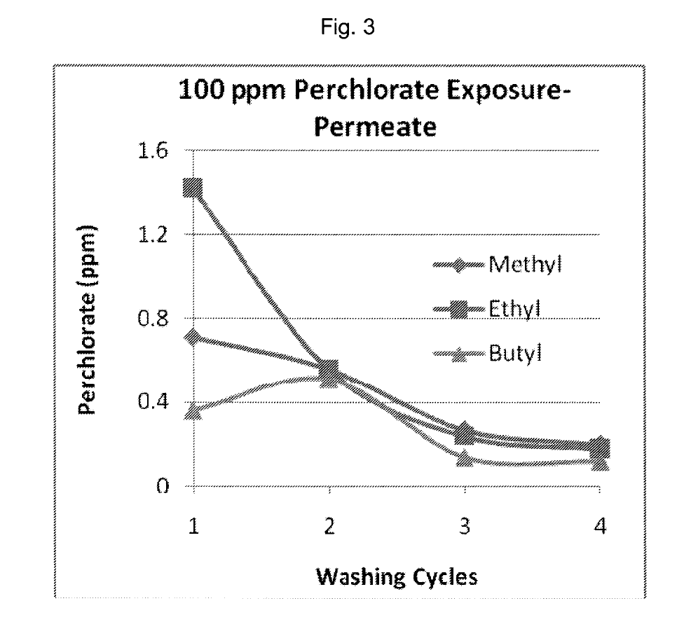

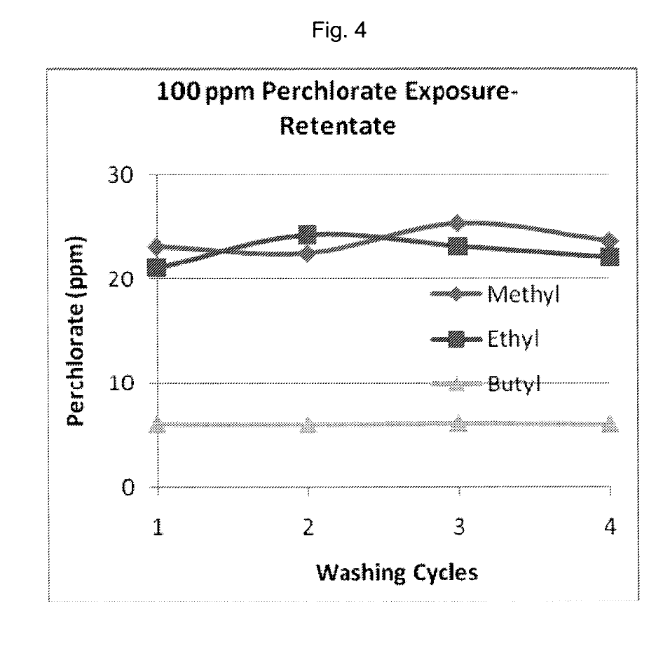

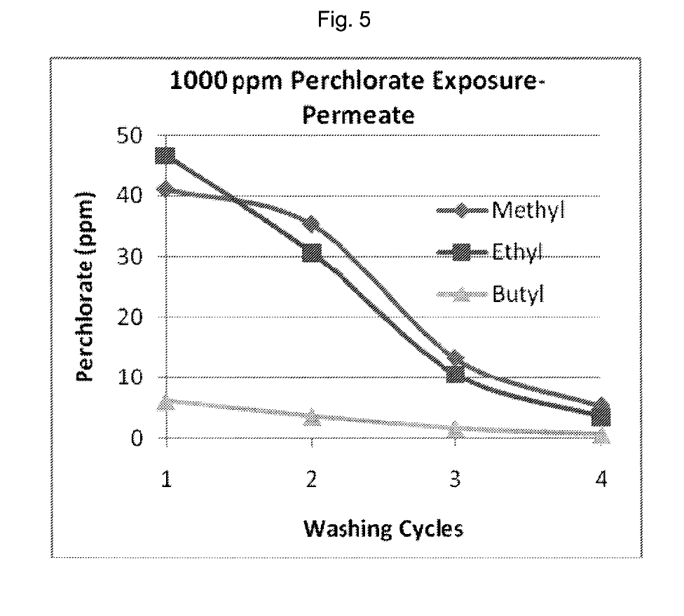

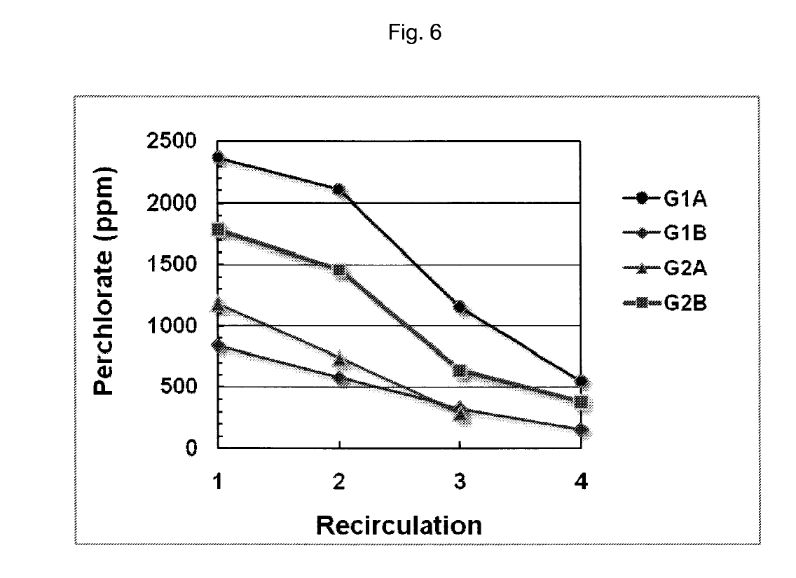

FIGS. 3-6 show comparisons of perchlorate retention of branched polymers with a G1(100-30) backbone with TMAC, TEAC, and TBAC binding sites. For 1,000 ppm and 10,000 ppm load, no major differences were found between the TMAC and TEAC binding site branched polymers, which showed binding efficiencies of about 98.5% and 90% removal of perchlorate. However the butyl samples were shown to have more efficient binding for perchlorate at 1,000 ppm load with 99.8% removal of perchlorate after two or more recirculations. All three branched polymers gave clear solutions except G1(100-30)-TBAC branched polymer. G1(100-30)-TBAC branched polymer with 1,000 ppm sodium perchlorate gave cloudy/milky solution. Samples collected from G1(100-30)-TBAC branched polymer retentate were turbid, whereas permeates were clear from the same experiment. On the other hand, 10,000 ppm sodium perchlorate-G1(100-30)-TBAC branched polymer solution was unsuitable for ultrafiltration due to precipitation. While not wishing to be bound by a particular theory, this may indicate that at high perchlorate exposures, the branched polymer captures the perchlorate molecule and renders the final product hydrophobic or creates a cross-linking effect. At high concentrations of perchlorate, the resin precipitated. Because crosslinked, solid resins were eventually used, this still indicates that the behavior of the TBAC resin might change considerably, e.g. the density would increase, likely resulting in increased pressure of operation. Not much of a difference was seen between the TMAC and TEAC binding site. Since the synthesis of the TMAC binding site is less expensive, TMAC-substituted branched polymers were used for future development. The data also clearly shows that we have the option, if needed, to develop a strong-base perchlorate-binding resin by using the TBAC branched polymer resins.

### Example 2

### Choice of Backbone

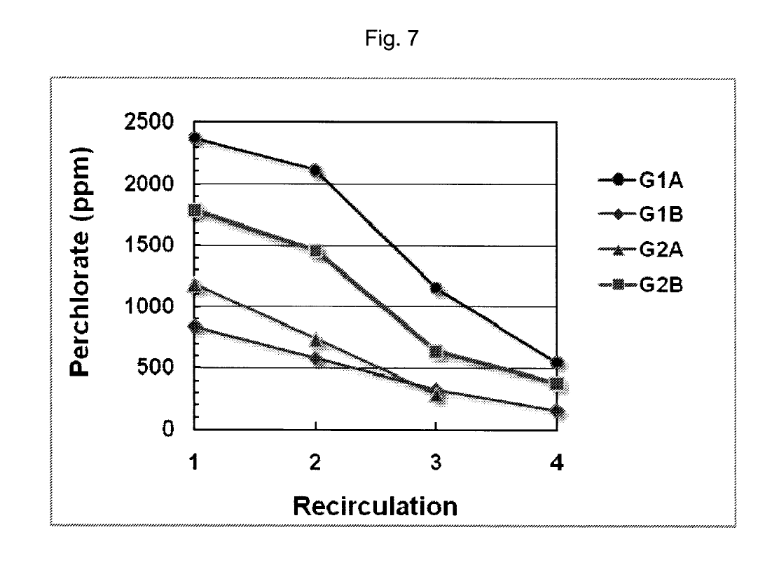

To determine if the size and amount of branching affects perchlorate binding, G1(100-30), G1(200-60), G2(100-30-15), and G2(200-60-30) were substituted with TMAC binding sites, and capacity was again determined by the ultrafiltration method for soluble resins (see FIG. 7). FIG. 7 is a graph comparing the perchlorate concentration as a function of time in a spiked water sample. The original perchlorate concentration was 10,000 ppm. Each branched polymer was functionalized with TMAC ligands for extraction of perchlorate. Referring to FIG. 7, both G1(200-60) and G2(100-30-15) were the most effective in removing perchlorate. Since a G1 branched polymer is cheaper to synthesize, G1(200-60)-TMAC became the lead candidate. In summary, G1(200-60)-TMAC was chosen for further study because:
The strongest binding came from the TBAC binding site, but it could not be regenerated, so it was excluded.
TEAC and TMAC were about equal in effectiveness, but TMAC is smaller, giving more access to the binding sites; it is also commercially available and cheap. So TMAC was chosen as the binding site.
Two backbones worked equally well: the short G2 (G2(100-30-15) and the long G1 (G1(200-60)). Since G1 is a step less in synthesis and thus less expensive to synthesize, G1(200-60) was chosen as the backbone.
Other hydrophilic branched polymers with TMAC binding sites can work as a polymer for this filter, even TEAC.

### Example 3

### Binding Capacity

Table 4 shows the results of a binding capacity experiment for soluble G1(200-60)-TMAC. To test the binding capacity, a 100 mL, 10,000 ppm perchlorate solution was recirculated four times through soluble G1(200-60)-TMAC using a cross-flow apparatus with a membrane. The amount of perchlorate absorbed was measured by comparing the perchlorate in the solution prior to introduction to the branched polymer with the perchlorate in the solution after being recirculated four times.

TABLE 4
Binding capacity values for G1(200-60)-TMAC as a function
of branched polymer material exposed to a 10,000 ppm solution
of perchlorate. Final perchlorate quantities determined from
the fourth recirculation (or longest exposure time) between
perchlorate and the branched polymer material.

| Branched Polymer | Absorbed Perchlorate | Binding Capacity |
|---|---|---|
| Mass (g) | (mg) | (meq) |
| 1 | 811 | 8.2 |
| 0.5 | 480 | 9.7 |
| 0.25 | 275 | 11.1 |
| 0.125 | 245 | 19.8 |
| 0.05 | 339 | 68.4 |
| 0.01 | 323 | 325.8 |

### Example 4

### Ion Selectivity

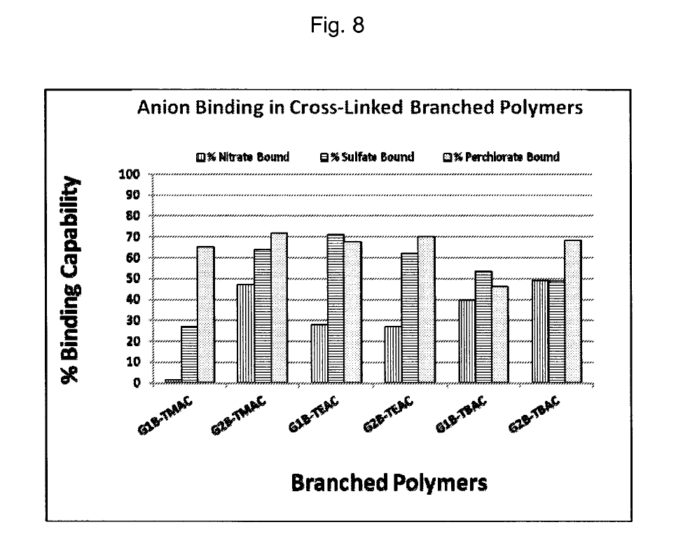

FIG. 8 shows relative ion selectivity of cross-linked branched polymers. Referring to FIG. 8, G1(200-60)-TMAC specifically binds perchlorate preferentially, but does not bind sulfate and nitrate as well. This characteristic has so far only been reported for extremely strong-binding resins that cannot be easily regenerated. Also, there may often be more nitrate and sulfate in water than perchlorate; therefore, no regenerable resin for perchlorate exists (for all regenerable resins nitrate and sulfate out compete perchlorate, so the resins all fill up with nitrate and sulfate and have no room to bind perchlorate).

### Example 5

### Sequential Binding of Ions to Branched Polymer Backbone

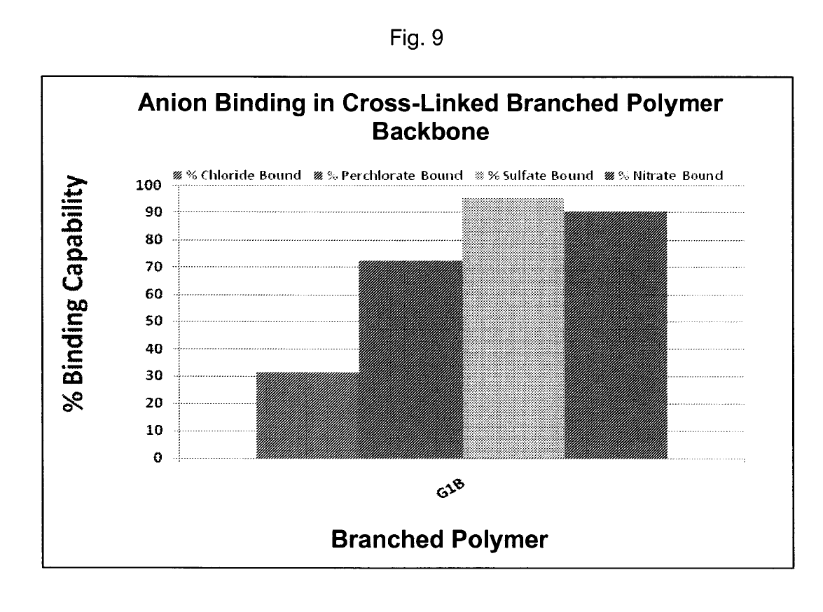

FIG. 9 is a graph showing the relative selectivity of a cross-linked branched polymer backbone resin G1(200-60), when exposed to chloride, nitrate, sulfate, or perchlorate ions. Branched polymer samples were treated with the following order: HCl, perchlorate, sulfate, and nitrate. Between each step branched polymers were regenerated with NaCl and then washed with DI water. After nitrate treatment, both the branched polymers were fully equilibrated and showed similar effluent chloride concentrations. High binding capability for sulfate and nitrate indicates that the branched polymer without binding site will preferentially bind sulfate and nitrate, thus leaving no capacity for binding perchlorate.

### Example 6

### Binding Site Regeneration

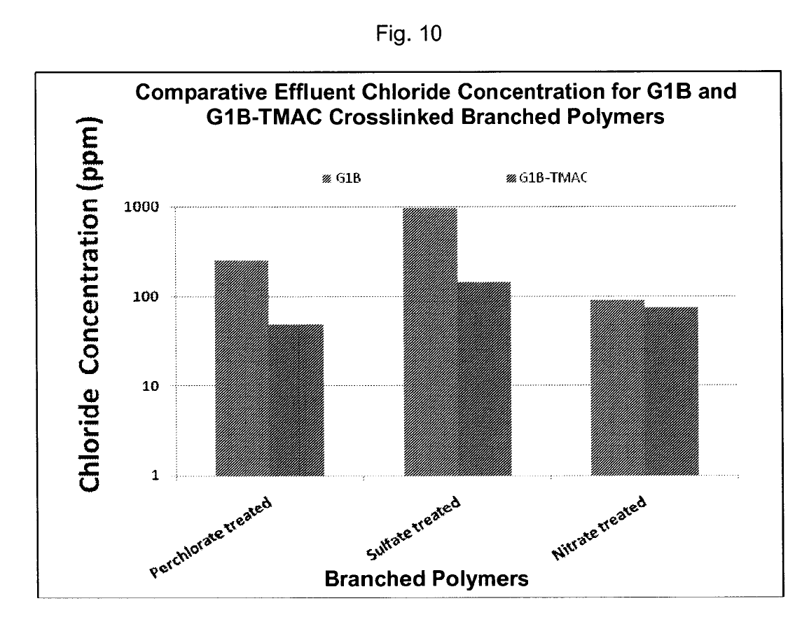

FIG. 10 is a graph summarizing experiments showing comparative effluent chloride concentration for G1(200-60) and G1(200-60)-TMAC cross-linked branched polymer samples for total capacity analysis. Referring to FIG. 10, the data show regeneration for the cross-linked, insoluble resins. However, because what are actually regenerated are the binding sites, and the binding sites are the same in the soluble and insoluble case, the data demonstrate that the soluble resins can be regenerated. This is the case particularly since in the insoluble resins, it is actually harder to regenerate, because access to the binding sites is restricted. Additionally, regeneration was accomplished with 0.1M NaCl solution, whereas 4M NaCl brine is commonly used.

1. An apparatus for removal of an ionic contaminant from a liquid comprising:
a branched polymer;
a filtration membrane; and
a filter casing.

2. The apparatus of claim 1, wherein the branched polymer comprises a backbone with a degree of polymerization of about 5 to about 800 or wherein the branched polymer comprises a molecular weight of about 5,000 to about 1,000,000 Da.

3-4. (canceled)

5. The apparatus of claim 1, wherein the branched polymer comprises a dendrimer or a hyperbranched polymer.

6. The apparatus of claim 1, wherein the branched polymer comprises a primary amine, a secondary amine, a tertiary amine, a quaternary amine, or a combination thereof.

7. (canceled)

8. The apparatus of claim 1, wherein the branched polymer comprises a perchlorate ion binding site.

9. The apparatus of claim 8, wherein the perchlorate ion binding site comprises tributyl ammonium chloride, triethyl ammonium chloride, trimethyl ammonium chloride, or a combination thereof.

10. The apparatus of claim 8, wherein the perchlorate ion binding site has a stronger binding affinity for perchlorate ions than for nitrate ions, or wherein the perchlorate ion binding site has a stronger binding affinity for perchlorate ions than for sulfate ions.

11-12. (canceled)

13. The apparatus of claim 1, wherein the filtration membrane comprises pores having a pore size from about 5 kDa to about 30 kDa.

14. The apparatus of claim 1, wherein the filtration membrane comprises about 0.01 mg to about 10 mg of a branched polymer per square centimeter of membrane.

15. The apparatus of claim 14, wherein the filtration membrane comprising the branched polymer has a total capacity for perchlorate ion of at least about 1 milli equivalents.

16-19. (canceled)

20. The apparatus of claim 1, wherein the filter casing is fluidly connected to a water faucet, a refrigerator water filter, a water filtration pitcher, or a combination thereof; and wherein the filter casing comprises an inlet or an outlet for regeneration fluids.

21. (canceled)

22. A method of removing an ionic contaminant from a liquid, the method comprising:
directing ion-contaminated liquid into an apparatus, the apparatus comprising:
a branched polymer;
a filtration membrane; and
a filter casing, wherein the filter casing comprises a first opening for admitting liquid and a second opening for releasing liquid;
contacting the ion-contaminated liquid with the branched polymer and directing the ion-contaminated liquid through the filtration membrane to produce a treated liquid; and
draining the treated liquid from the apparatus through the second opening.

23-36. (canceled)

37. The method of claim 22, further comprising the step of regenerating the filtration membrane and branched polymer.

38. The method of claim 37, wherein regenerating comprises exposing the filtration membrane and branched polymer to a saline solution.

39. The method of claim 38, wherein the saline solution comprises less than about 1 M sodium chloride.

40. (canceled)

41. The method of claim 22, wherein the filter casing is fluidly connected to a water faucet, a refrigerator water filter, a water filtration pitcher, or a combination thereof.

42. The method of claim 22, wherein the filter casing further comprises a third opening for the release of membrane regeneration fluids.

43. The apparatus of claim 1, wherein the liquid comprises water, and wherein the ionic contaminant comprises the a perchlorate ion.

44. (canceled)

45. The method of claim 22, wherein the ion-contaminated liquid comprises perchlorate ion-contaminated water.

46. (canceled)

47. The method of claim 22, wherein the treated liquid contains less than about 24.5 parts per billion of perchlorate ion.

48. (canceled)
